(19) United States
(12) Patent Application Publication
(10) Pub. No.: US 2025/0200869 A1
(43) Pub. Date: Jun. 19, 2025

(54) SYSTEM AND METHOD FOR TRANSPARENCY SORTING

(71) Applicant: Sony Interactive Entertainment Europe Limited, London (GB)

(72) Inventors: Lawrence Martin GREEN, London (GB); Oliver George HUME, London (GB)

(73) Assignee: Sony Interactive Entertainment Europe Limited, London (GB)

(21) Appl. No.: 18/980,201

(22) Filed: Dec. 13, 2024

(30) Foreign Application Priority Data
Dec. 15, 2023 (GB) 2319215.6

(51) Int. Cl. G06T 15/40

(52) U.S. Cl. CPC G06T 15/40; G06T 2210/62

(57) ABSTRACT

There is described a computer-implemented method comprising: receiving, at a processing device, data defining a first virtual scene associated with a client computing device, wherein the first virtual scene comprises a plurality of virtual objects; performing, by the processing device, transparency sorting of the virtual objects, wherein said transparency sorting comprises assigning each virtual object of the plurality of virtual objects to a respective plane of an overlapping stack of planes forming the first virtual scene; transmitting, from the processing device to the client computing device, information defining an order in which the plurality of objects should be drawn based on the overlapping stack of planes. There is also described a further computer-implemented method, computer program product and a system.

### CROSS-REFERENCE TO RELATED APPLICATIONS

The present application claims priority from British Patent Application No. 2319215.6 filed Dec. 15, 2023, the contents of which are incorporated herein by reference in its entirety.

### FIELD OF THE INVENTION

The present invention relates to computer-implemented methods, computer program products and systems for transparency sorting.

### BACKGROUND TO THE INVENTION

A virtual scene, such as a scene in a video game comprising rendered graphical content, generally comprises a plurality of virtual objects. These virtual objects can represent three-dimensional objects which are rendered as two-dimensional objects when viewed from a desired camera position.

These virtual objects can partially or fully overlap and obscure one another when viewed from the desired camera position. As such, there is a need to determine the order in which the virtual objects are rendered such that the virtual objects overlap in the desired manner.

Determining the order in which the virtual objects are rendered is challenging, in particular if the virtual objects are moving or the camera position is changing. Additionally, determining the order in which the virtual objects are rendered is complex and demands computational resource from the local computing device.

Objects and aspects of the present claimed invention seek to alleviate at least these problems with the prior art.

### SUMMARY OF THE INVENTION

According to a first aspect of the invention, there is provided a computer-implemented method comprising: receiving, at a processing device, data defining a first virtual scene associated with a client computing device, wherein the first virtual scene comprises a plurality of virtual objects; performing, by the processing device, transparency sorting of the virtual objects, wherein said transparency sorting comprises assigning each virtual object of the plurality of virtual objects to a respective plane of an overlapping stack of planes forming the first virtual scene; transmitting, from the processing device to the client computing device, information defining an order in which the plurality of objects should be drawn based on the overlapping stack of planes.

In the present disclosure, the processing device is remote to the client computing device. In other words, the processing device does not form part of the client computing device.

The first aspect provides an improved method of transparency sorting wherein transparency sorting occurs at the processing device and information regarding the transparency sorting is transmitted to the client computing device. In this way, the computational demand on the client computing device is reduced as the determining the order in which the plurality of objects are drawn is performed externally.

The method allows the plurality of virtual objects to be rendered in the optimal order to capture the camera position from which the virtual scene is viewed. The camera position may be considered as the position determining which of the plurality of two-dimensional views of the three-dimensional graphical scene will be rendered. For example, during video gameplay the camera position may move automatically when the user moves their character within the scene or when the user otherwise manually pans the camera position around the scene.

Information defining an order may comprise a draw call order. The draw call order is the order in which the plurality of virtual objects, or portions of the plurality of virtual objects, are rendered in a render pipeline. For a first virtual object preceding a second virtual object in the draw call order, the first virtual object will be rendered prior to or earlier than rendering of the second virtual object, thereby allowing the second virtual object to occlude the first virtual object and appear ‘closer’ to the camera position.

It will be appreciated that two or more virtual objects may be assigned to the same plane in the overlapping stack of planes forming the virtual scene.

In some embodiments, the processing device is a cloud computing device. In this way, the transparency sorting is performed on the cloud computing device and is transmitted to the client computing device, such as a video game console.

In some embodiments, the method comprises determining, by the processing device, a visibility of each virtual object of the plurality of virtual objects. In response to determining that a portion of a virtual object is occluded, the method may comprise transmitting, from the processing device to the client computing device, information indicating that the occluded portion of the virtual object should not be rendered. In some embodiments, determining the visibility may include determining a status of visibility. For example, the status of visibility may be fully visible, partially visible or not visible and a portion of a virtual object may be considered occluded when the status of visibility is partially visible or not visible. In this way, it can be determined which portions of the plurality of virtual objects are occluded and therefore overlap with other virtual objects when considered from the desired camera position.

In some embodiments, performing the transparency sorting comprises determining a characteristic of a first virtual object of the plurality of virtual objects and determining a characteristic of a second virtual object of the plurality of virtual objects, comparing the characteristic of the first virtual object and the characteristic of the second virtual object, assigning, at least partially based on the comparison, the first virtual object to a first plane and the second virtual object to a second plane, and defining a relative order of the first plane and the second plane in the overlapping stack. In this way, the information defining an order of the virtual objects (e.g. the draw call order of the plurality of virtual objects) can be determined at least partially based on the characteristics of the virtual objects.

In some embodiments, the characteristic is a depth characteristic, an opacity characteristic or a render priority ranking.

A depth characteristic may comprise a distance from the virtual object to a camera position. An opacity characteristic may comprise a percentage opacity, namely the degree to which the virtual object is hidden. A render priority ranking may be determined by one or more of: the distance of the virtual object from a camera position, the importance of a virtual object relative to the plurality of virtual objects; the size of the virtual object, the complexity of the virtual object, the colour of the virtual object and/or the location of the virtual object in the virtual scene.

In some embodiments, the method comprises determining at least one portion of overlap between the first virtual object and the second virtual object, and determining a characteristic of the portion of overlap. In some embodiments, the characteristic is a colour or a hue. For example, if a first virtual object is partially transparent, the portion of the first virtual object overlapping the second virtual object will include the partially obscured second virtual object. For example, the first virtual object may be a partially transparent blue tinted window and the second virtual object may be a character located behind, and entirely overlapping with, the tinted window. In such an embodiment, the character would be visible through the tinted window, but would appear to have a blue hue due to the opacity property of the window. In another example, if a yellow virtual object is located in front of a red virtual object, and the yellow virtual object is partially transparent, the portion of overlap will have an orange colour.

In some embodiments, performing the transparency sorting comprises dividing the first virtual scene into a plurality of sub-portions. It will be appreciated that this division is a notional or mathematical construct, and that the virtual scene is not “physically” separated into a plurality of sub-portions.

Optionally, one or more of the plurality of virtual objects spans at least two of the plurality of sub-portions. Thus, a first portion of a virtual object may be located in the first sub-portion of the virtual scene, and a second portion of a virtual object may be located in the second sub-portion of the virtual scene.

In a first sub-portion of the virtual scene, a first virtual object may obscure a second virtual object but in a second sub-portion of the virtual scene, the second virtual object may obscure the first virtual object. As such, in this situation, it is undesirable to assign the entirety of the first virtual object to a first plane and the entirety of the second virtual object to a second plane. In such a case, regardless of the order of the stack of planes, the draw call order will be incorrect for either the first sub-portion or the second sub-portion of the virtual scene because the first virtual object does not always obscure the second virtual object in the portions of overlap.

In some embodiments, performing the transparency sorting comprises assigning each virtual object of the plurality of virtual objects in a first sub-portion to a respective plane of a first overlapping stack of planes forming the first sub-portion of the first virtual scene; and assigning each virtual object of the plurality of virtual objects in a second sub-portion to a respective plane of a second overlapping stack of planes forming the second sub-portion of the virtual scene. In this way, when there are a plurality of overlapping virtual objects in the virtual scene, the order in which the plurality of objects should be drawn can be defined relative to each sub-portion.

Thus, the method may include assigning each virtual object of the plurality of virtual objects in a given sub-portion to a respective plane of an overlapping stack of planes forming the given sub-portion.

The method may include transmitting, from the processing device to the client computing device, information defining an order in which the plurality of virtual objects should be drawn in each sub-portion of the virtual scene.

In other words, each sub-portion of the virtual scene may comprise a respective overlapping stack of planes. Each virtual object, or portion of a virtual object, in a sub-portion of the virtual scene may be assigned to a plane in the overlapping stack of planes forming the sub-portion. Thus, a first potion of a virtual object may be allocated to a first plane of the first overlapping stack of planes forming the first sub-portion of the virtual scene, and a second portion of said virtual object may be allocated to a second plane of the second overlapping stack of planes forming the second sub-portion of the virtual scene. It will be appreciated that two or more virtual objects, or portions of virtual objects, may be allocated to the same plane in a given sub-portion of the virtual scene.

In some embodiments, dividing the first virtual scene into a plurality of sub-portions comprises defining each sub-portion by a grid. Thus, dividing the first virtual scene into a plurality of sub-portions may comprise dividing the first virtual scene into a grid, wherein each sub-portion is a section of the grid. It is understood that the grid may comprise a plurality of straight and/or curved lines. In some embodiments, the lines of the grid are equidistant. In other embodiments, the lines of the grid are determined by the shape and/or location of the plurality of virtual objects.

In some embodiments, the method further comprises storing, at the processing device or a remote storage resource associated with the processing device, the information defining the order in which the plurality of objects should be drawn and/or the plane(s) assigned to each virtual object in the first virtual scene. In this way, data regarding the virtual scene can be recalled and reused in future transparency rendering of subsequent virtual scenes, thereby improving the efficiency of the method and reducing computational resource demand.

It will be appreciated that the method may be repeated for a plurality of virtual scenes.

In some embodiments, the method further comprises receiving, at the processing device, data defining a second virtual scene associated with the client computing device, wherein the second virtual scene succeeds the first virtual scene and the second virtual scene comprises a second plurality of virtual objects.

The method may include performing, by the processing device, transparency sorting of the virtual objects in the second virtual scene, wherein said transparency sorting comprises assigning each virtual object of the second plurality of virtual objects to a respective plane of an overlapping stack of planes forming the second virtual scene.

The method may include transmitting, from the processing device to the client computing device, information defining an order in which the second plurality of objects should be drawn in the second virtual scene based on the overlapping stack of planes. In this way, as the plurality of virtual objects move and/or as the camera positon changes, a new draw call order can be determined.

In some embodiments, transmitting, from the processing device to the client computing device, information defining an order in which the plurality of objects should be drawn in the second virtual scene comprises comparing the information defining the plane assigned to each virtual object in the second virtual scene to the information defining the plane assigned to each virtual object in the first virtual scene, and transmitting the delta, or differences, between the first virtual scene and the second virtual scene. In this way, the draw call order of the first virtual scene can be updated to provide the draw call order of the second virtual scene by applying the delta, or the differences between the draw call order of the first virtual scene and the desired draw call order of the second virtual scene. As such, any information (regarding the draw order of virtual objects) that has not changed between the two virtual scenes is not re-transmitted, only the differences between the two virtual scenes are transmitted to the client computing device, thereby saving computational resources and reducing latency.

In some embodiments, the method further comprises identifying one or more virtual objects that are common between the first virtual scene and the second virtual scene and assigning each common virtual object a respective predicted plane in the overlapping stack of planes forming the second virtual scene, at least partially based on the plane assigned to the virtual object in the first virtual scene. As such, prior computational work performed for the first virtual scene can be recalled and re-used to provide the draw call order of the second virtual scene to improve efficiency. A virtual object is unlikely to jump from the back to the front of the stack of overlapping planes between successive scenes. In this way, the processing device may predict or anticipate the draw call order of the plurality of virtual objects in the stack of overlapping planes for a subsequent virtual scene based on information from the prior virtual scene.

Optionally, information comprising the predicted plane of one or more common virtual object is transmitted to the client computing device. In this way, predicted information defining the plane assigned to each virtual object, such as the sort order, can be transmitted to the client computing device, allowing an initial rough render of the virtual scene to be generated. The initial render may subsequently be updated when the information defining an order in which the plurality of objects should be drawn based on the overlapping stack of planes is determined and transmitted to the client computing device.

In some embodiments, performing transparency sorting of the virtual objects in the second virtual scene comprises updating the respective predicted plane assigned to each common virtual object to a respective finalised plane assigned to each common virtual object. It is understood that the finalised plane is the plane to which each virtual object is assigned for rendering. The finalised draw call order transmitted from the processing device to the client computing device comprises the plurality of virtual objects assigned to their finalised plane.

According to a second aspect of the present invention, there is provided a computer-implemented method comprising sending, to a processing device, data defining a first virtual scene associated with a client computing device, the first virtual scene comprising a plurality of virtual objects, wherein each virtual object of the plurality of virtual objects is assigned a respective plane of an overlapping stack of planes forming the first virtual scene, receiving, at the client computing device, information defining an order in which the plurality of objects should be drawn in the first virtual scene based on the overlapping stack of planes, and rendering, at the client computing device, the first virtual scene.

The second aspect of the invention also provides an improved method of transparency sorting wherein transparency sorting occurs at the processing device and information regarding the transparency sorting is transmitted to the client computing device. In this way, the computational demand on the client computing device is reduced, as determining the order in which the plurality of objects are drawn is performed externally at the processing resource.

In some embodiments, the method further comprises receiving, at the client computing device, information regarding a plurality of sub-portions. In some embodiments, rendering, at the client computing device, the first virtual scene comprises rendering the plurality of sub-portions in a predetermined order. For example, the order may be determined by one or more of: proximity to the camera position; quantity of virtual objects in each sub-portion, percentage of each sub-portion containing a virtual object; complexity of virtual objects in each sub-portion and/or determined from a clockwise or anticlockwise direction.

The information defining an order in which the plurality of objects should be drawn may define the plane(s) assigned to each virtual object.

The information defining an order in which the plurality of objects should be drawn may comprise a draw call order.

In some embodiments, the first virtual scene is divided into a plurality of sub-portions and receiving, at the client computing device, the information defining an order in which the plurality of objects should be drawn in the first virtual scene, comprises receiving information defining an order in which the plurality of virtual objects should be drawn in each sub-portion of the first virtual scene.

In some embodiments, the method further comprises receiving information indicating that a portion of one of the virtual objects of the plurality of virtual objects in the first virtual scene is occluded, and removing data defining the occluded portion of the virtual object from data defining the first virtual scene for rendering, such that rendering the first virtual scene does not include rendering the occluded portion of the virtual object. In this way, the occluded portion of the virtual object is not unnecessarily rendered when it will not be seen in the virtual scene from the camera position. Such a function allows a ‘visibility check’ to be performed. Namely, if a portion of a virtual object is not visible because it is hidden from view behind another virtual object, the processing device can inform the client computing device not to rendering the occluded portion of the visual object, thereby reducing computational resource spent on unnecessary rendering.

Optionally, the first virtual scene may be divided into a plurality of sub-portions. The method may include receiving, from the processing device, information defining an order in which the plurality of virtual objects should be drawn in each sub-portion of the first virtual scene.

It will be appreciated that the method may be repeated for a plurality of virtual scenes.

In some embodiments, the method further comprises receiving, at the client computing device, information defining an order in which a second plurality of objects should be drawn in a second virtual scene, the second virtual scene succeeding the first virtual scene, and rendering, at the client computing device, the second virtual scene.

In some embodiments, the information defining an order in which a second plurality of objects should be drawn defines the plane(s) assigned to each virtual object in the second virtual scene.

In some embodiments, the information defining an order in which a second plurality of objects should be drawn in the virtual scene comprises the delta, or differences, between the first virtual scene and the second virtual scene. In this way, the information or draw call order of the first virtual scene can be updated to provide the information or draw call order of the second virtual scene based on the delta, or the differences between the draw call order of the first virtual scene and the second virtual scene. In this way, only the differences between the two virtual scenes can be received by the client computing device, thereby saving computational resources.

In some embodiments, the method further comprises an initial step of initiating, on the client computing device, a video game, the video game comprising a plurality of virtual scenes. The method of the first and second aspects of the invention are particularly advantageous in the field of video game rendering.

According to a third aspect of the present invention, there is provided a computer program product including one or more executable instructions which, when executed by a computer, cause the computer to carry out the method of the first aspect of the invention and/or the second aspect of the invention.

According to a fourth aspect of the present invention, there is provided a computing system configured to carry out the computer-implemented method of the first aspect of the invention and/or the second aspect of the invention.

### BRIEF DESCRIPTION OF THE DRAWINGS

Embodiments of the present invention will now be described by way of example only and with reference to the accompanying drawings, in which:

FIG. 1 depicts a flow diagram of a method according to an embodiment of the first aspect of the present disclosure;

FIG. 2 depicts a flow diagram of a second embodiment of a method according to the first aspect of the present disclosure;

FIGS. 3a to 3c depict aspects of a virtual scene produced from the method of FIG. 1;

FIGS. 4a to 4c depict aspects of a virtual scene according to a further embodiment of the present disclosure;

FIG. 5 depicts a flow diagram according to the embodiment shown in FIGS. 4a to 4c;

FIG. 6 is a schematic diagram illustrating a computing system that may be used in accordance with this disclosure; and

FIG. 7 is a block diagram of one example implementation of a computing device.

### DETAILED DESCRIPTION

The following detailed description is merely illustrative in nature and is not intended to limit the embodiments of the subject matter or the application and uses of such embodiments. As used herein, the words “exemplary” and “example” mean “serving as an example, instance, or illustration.” Any implementation described herein as exemplary or an example is not necessarily to be construed as preferred or advantageous over other implementations. Furthermore, there is no intention to be bound by any expressed or implied theory presented in the preceding technical field, background, or the following detailed description.

The present disclosure provides a method for transparency sorting, wherein information regarding the draw call order in which a plurality of virtual objects are to be rendered can be transmitted from the processing device to be received at a client computing device. In the following description, examples relating to video game rendering are provided, wherein the examples describe a video game virtual scene.

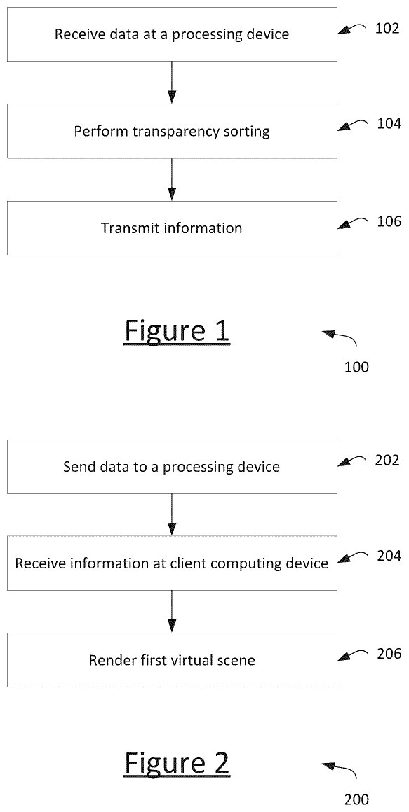

With reference to FIG. 1, a flow diagram of a method 100 according to the first aspect is provided. Method 100 is from the perspective of a remote processing device.

In step 102, data defining a first virtual scene associated with a client computing device is received at a processing device. The processing device may be a cloud computing device, a remote server, or other remote processor. The client computing device may comprise, but is not limited to, a personal computer (PC), a tablet computer, a set-top box (STB), a Personal Digital Assistant (PDA), a cellular telephone, a web appliance, a server, a network router, switch or bridge or any other machine capable of displaying a virtual scene. The first virtual scene comprises a plurality of virtual objects. For example, the plurality of virtual objects may comprise virtual infrastructure such as walls or buildings, ambient environment objects, interactive environment objects, virtual characters or players and/or text and other speech boxes or scene overlays.

In step 104, transparency sorting of the virtual objects is performed by the processing device. Typically, the transparency sorting would be performed at the client computing device, however, in the present disclosure this task is outsourced to the processing device. The transparency sorting comprises assigning each virtual object of the plurality of virtual objects to a respective plane of an overlapping stack of planes forming the first virtual scene. It is submitted that various techniques for transparency sorting are known in the art, and can be used in the present disclosure.

In step 106, information defining an order in which the plurality of objects should be drawn based on the overlapping stack of planes in the first virtual scene, is transmitted from the processing device to the client computing device. The processing device may have improved processing speeds or capability compared to the client computing device. Accordingly, this method reduces the computational burden of the client computing device and can improve efficiency and therefore reduce delays for the user.

With reference to FIG. 2, a flow diagram of a method 200 according to the first aspect of this disclosure is provided. Method 200 is from the perspective of the client computing device.

In step 202, data defining a first virtual scene associated with a client computing device is sent to a processing device.

As in method 100, the client computing device may comprise, but is not limited to, a personal computer (PC), a tablet computer, a set-top box (STB), a Personal Digital Assistant (PDA), a cellular telephone, a web appliance, a server, a network router, switch or bridge or any other machine capable of displaying a virtual scene. The first virtual scene comprises a plurality of virtual objects, wherein each virtual object of the plurality of virtual objects is assigned a respective plane of an overlapping stack of planes forming the first virtual scene. In this way, the order of the overlapping stack of planes provides the draw call order in which the plurality of virtual objects are to be rendered.

In step 204, information defining an order in which the plurality of objects should be drawn based on the overlapping stack of planes is received at the client computing device. In step 206, the first virtual scene is rendered at the client computing device.

In this way, both methods 100, 200 provide an improved means of transparency sorting wherein determining the draw call order of the plurality of virtual objects occurs at the processing device, with this information being transmitted to the client computing device.

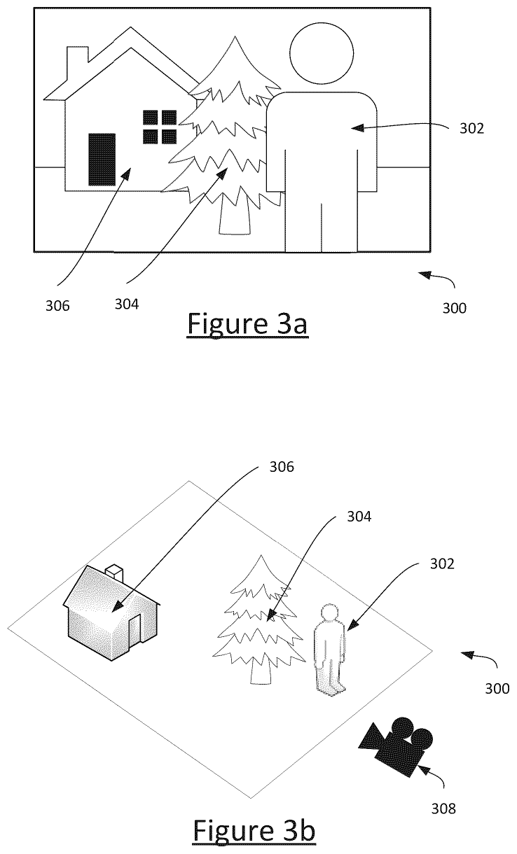

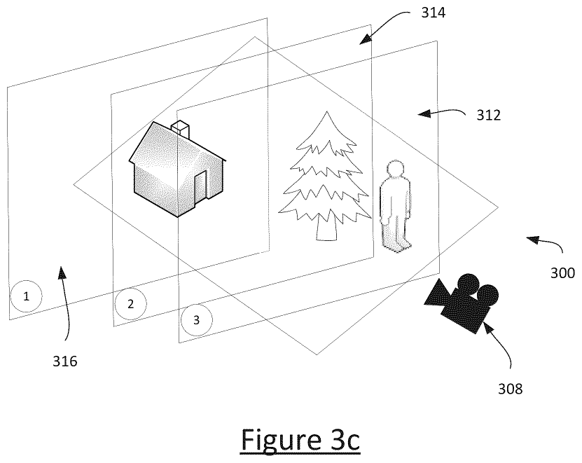

With reference to FIGS. 3a to 3c, a first virtual scene 300 is illustrated. The first virtual scene 300 comprises three virtual objects: a character 302, a tree 304 and a building 306. FIG. 3a illustrates how the virtual scene 300 appears when displayed in two-dimensions by the client computing device. The camera position 308 is illustrated in FIG. 3b alongside the three-dimensional positions of the character 302, tree 304 and building 306 within the virtual scene 300.

The building 306 is located furthest from the camera position 308 and the character 302 is located in the foreground, closest to the camera position 308. The tree 304 is located between the building 306 and the character 302.

During transparency sorting, each virtual object is assigned a respective plane of an overlapping stack of parallel planes. The building 206 is assigned a first plane 316, the tree 304 is assigned a second plane 304a and the character 312 is assigned a third plane 312. The first plane 316 is located furthest from the camera position 308 and the third plane 312 is located closest to the camera position 308. The second plane 314 is located between the first plane 316 and the third plane 312. Relative to the camera position 308, the three planes 312, 314, 316 form a stack of planes in a direction perpendicular to the direction the virtual scene 300 is viewed from the camera position 308. It will be appreciated that in some embodiments, or some virtual scenes, more than one virtual object may be assigned to the same plane.

The distance between each plane 312, 314, 316 is dependent on the respective distances between the virtual objects 302, 304, 306 in three-dimensional space. As illustrated in FIG. 3c, the planes 312, 314, 316 are not equidistant. It is understood that the term overlapping refers to the overlap present in the direction of the camera position 308, such that virtual objects assigned to each plane may overlap and occlude one another in the virtual scene 300.

In this way, information defining the order in which the plurality of objects 302, 304, 306 should be drawn is based on the order of the overlapping stack of planes 312, 314, 316. Namely, the virtual object assigned to the first plane 316 furthest from the camera position 308 is to be rendered first, followed by the virtual object assigned to the second plane 314 followed by the virtual object assigned to the third plane 312, which is located closest to the camera position 208. This information is typically provided as a draw call order, which defines the order in which the virtual objects should be rendered.

In this way, the portion of the tree 304 overlapping the building 306 is shown and the portion of the building 306 is occluded. The portion of character 302 overlapping the tree 304 is shown and the portion of the tree 304 is occluded. As such, overlapping portions of virtual objects in the foreground are rendered and shown in the virtual scene and any overlapping portions of virtual objects in the background are fully or partially occluded by the foreground virtual objects after rendering.

It will be appreciated that the transparency of a given virtual object will affect whether or not a portion of another virtual object that is positioned behind the given virtual object will be visible, or partially visible, or completely occluded. For example, if the character 302 is completely opaque, then the portion of the tree 304 which is overlapped by the character 302 will not be visible. As such, the information sent by the processing device may instruct the client computing device not to render that portion of the tree 304, as it is not visible in the scene. However, if the character 302 is translucent or semi-transparent, then the portion of the tree 304 will be at least partially visible through the character 302.

Thus, the transparency sorting of the virtual objects may comprise determining at least one characteristic of each of the virtual objects 302, 304, 306. This characteristic may be one or more of a depth characteristic, an opacity characteristic or a render priority ranking. The method may include comparing the characteristics of the virtual objects. The assigning of each virtual object to a respective plane may be at least partially based on the comparison.

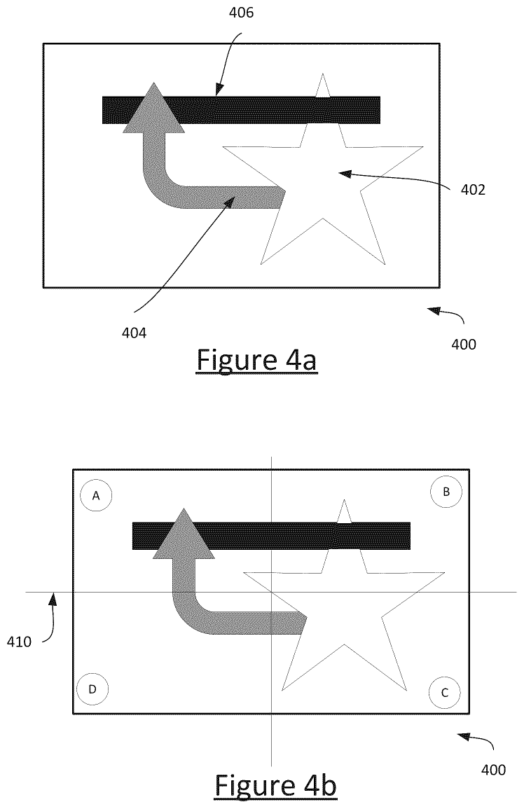

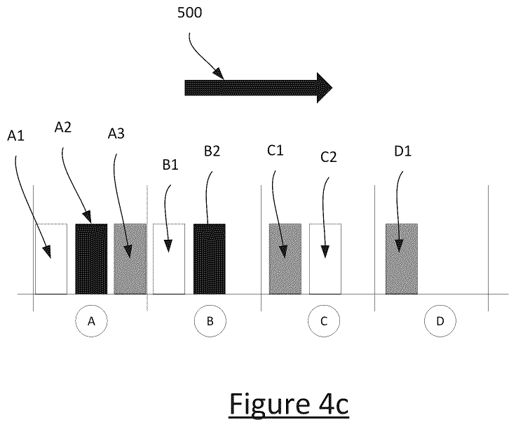

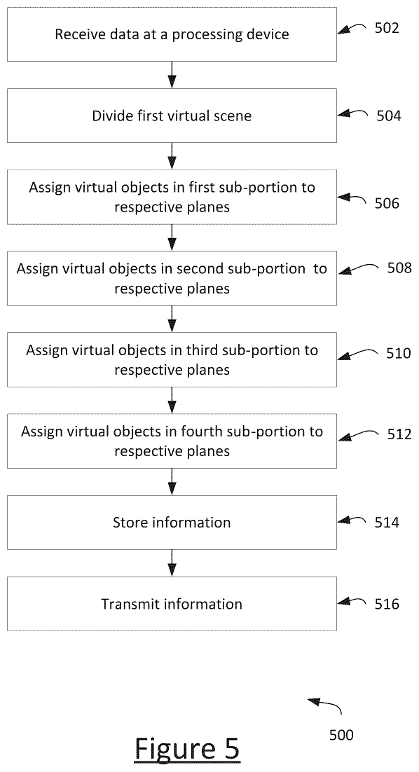

With reference to FIGS. 4a to 4c, a second embodiment of a first virtual scene 400 is illustrated. FIGS. 4a to 4c should be considered in combination with FIG. 5 which is a flow chart of the corresponding method steps.

The first virtual scene 400 comprises three virtual objects: a star 402, an arrow 404 and a block 404. As illustrated in FIG. 4a, the star 402 is located closer to the camera position than the arrow 404; the arrow 404 is located closer to the camera position than the block 406; and the block 406 is located closer to the camera position than the star 402. As such, assigning each virtual object to a single plane would prevent the virtual objects from being rendered correctly.

Therefore, to resolve this problem the first virtual scene 400 can be divided into a grid 410 comprising a first sub-portion A, a second sub-portion b, a third sub-portion C and a fourth sub-portion D. This is shown as step 504 in FIG. 5. It will be appreciated that the number, shape and/or size of sub-portions in which the virtual scene 400 is to be divided into may be determined based on one or more factors. For example, the number, shape and/or size of sub-portions may be determined by the total number of virtual objects in the scene; the number of virtual objects located within a sub-portion; and/or the capacity of the processing device. In some embodiments, the plurality of sub-portions are identical in size and shape. In some embodiments, the shape of the sub-portions is determined in a manner that an equal number of virtual objects are located within each sub-portion.

Considering each sub-portion in turn, each portion of the virtual object located within the sub-portion can be assigned a respective plane of the sub-portion. Thus, each sub-portion can be formed of a respective overlapping stack of planes that together form the first virtual scene 400. A draw call order 500 can then be determined for each sub-portion of the virtual scene based on the order of the planes in the overlapping stack of planes. In the description below, the virtual object referenced is only the portion of the virtual object located within the sub-portion.

In the first sub-portion A, the arrow 404 is located closer to the camera position than the block 406. The star 402 does not overlap the other two virtual objects (in the first sub-portion A) and so it does not matter whether the star 402 is rendered before or after the other two virtual objects. For example, the star 402 can be assigned a first plane A1, the block 406 can be assigned a second plane A2 and the arrow 404, located in the foreground, can be assigned a third plane A3. The first plane A1 is configured to be the first plane rendered in the draw call order 500, followed by the second plane A2 followed by the third plane A3. In this way, the star 402 is rendered in the background, followed by the block 406 and the arrow 404 is rendered in the foreground.

In another example, in the first sub-portion A the portion of the star 402 may be assigned to the same plane (A1) as the block 406, or the same plane (A2) as the arrow 404.

For each sub-portion of the scene, a portion of the draw call order 500 is determined. Thus, each sub-portion can be considered to have a respective stack of planes which, when considered together, form the overlapping stack of planes defining the scene.

In this embodiment, for the second sub-portion B, the star 402 is assigned a fourth plane B1 and the block 406 is assigned a fifth plane B2 such that the portion of the star 402 overlapping the block 406 is occluded by the block 406 as the star 402 is rendered before the block 406.

For the third sub-portion C, the arrow 404 is assigned a sixth plane C1 and the star 402 is assigned a seventh plane C2 such that the portion of the arrow 404 overlapping the star 402 is occluded by the star 402. For the fourth sub-portion D, the arrow 404 is the only virtual object located within the sub-portion D. Therefore, the arrow is assigned the eighth plane D1 and is the final portion of the virtual scene 400 to be rendered in the draw call order 500. It is understood that the number of the plane corresponds to the plane's order in the overlapping stack of planes, with the first plane A1 being first in the draw order 500 and the eighth plane D1 being last.

In this example, the order in which the plurality of objects should be drawn based on the overlapping stack of planes follows the order 500 illustrated on FIG. 4c, from the first plane A1 to the eight plane D1. It is appreciated that the planes may are stacked parallel to one another such that three quarters of each plane is empty and one quarter comprises the sub-portion of the virtual scene 400. In this example, the priority of rendering of the sub-portions follows clockwise about the virtual scene 400 from the upper left corner.

It will be appreciated that the sub-portions of the scene could be rendered in any order, such that the draw call in FIG. 4c could be re-ordered.

With reference to FIG. 5, the method described above in connection with FIGS. 4a to 4c is described is depicted in a flow chart. The method 500 comprises the following steps.

In step 502, data defining a first virtual scene associated with a client computing device is received at a processing device. The first virtual scene may be a scene in a video game (or computer game). The first virtual scene comprises a plurality of virtual objects. For example, the plurality of objects may comprise a star 402, an arrow 404 and a block 404 as illustrated in FIG. 4a. The virtual scene 400 is used in this embodiment of the method 500.

Transparency sorting of the virtual objects is performed by the processing device. The transparency sorting comprises, in step 504, dividing the first virtual scene into a plurality of sub-portions, wherein one or more of the plurality of virtual objects spans at least two of the plurality of sub-portions. An example of dividing the first virtual scene into four sub-scenes is illustrated in FIG. 4b, but it will be appreciated that any number or shape of sub-portions may be provided.

In step 506, each virtual object of the plurality of virtual objects in a first sub-portion (e.g. sub-portion A) is assigned to a respective plane of a first overlapping stack of planes that form the first sub-portion. In step 508, each virtual object of the plurality of virtual objects in the second sub-portion (e.g. sub-portion B) is assigned to a respective plane of a second overlapping stack of planes that form the second sub-portion. In step 510, each virtual object of the plurality of virtual objects in the third sub-portion (e.g. sub-portion C) is assigned to a respective plane of a third overlapping stack of planes that form the third sub-portion. In step 512, each virtual object of the plurality of virtual objects in the fourth sub-portion (e.g. sub-portion D) is assigned to a respective plane of a fourth overlapping stack of planes that form the fourth sub-portion.

In this way, the stack of planes from each sub-portion can be combined to provide a draw call order for the virtual objects, as depicted in FIG. 4c, and the portions of the virtual objects located in all four sub-portions can be rendered to produce the virtual scene.

In step 514, at the processing device or a remote storage resource associated with the processing device, the information defining the order in which the plurality of objects should be drawn and/or the plane assigned to each virtual object in the first virtual scene is stored. This is an optional step.

In step 516, information defining an order in which the plurality of objects should be drawn based on the overlapping stack of planes, the plane assigned to each virtual object in the first virtual scene, is transmitted from the processing device to the client computing device. In this way, rendering of the virtual scene can be performed more accurately and efficiently.

It will be appreciated that FIG. 5 shows the method for remote transparency sorting of a first virtual scene, and that this can be repeated for a plurality of virtual scenes. For a second virtual scene subsequent to the first virtual scene, step 516 may comprise transmitting the differences (or delta) between the information defining the draw order of the first virtual scene and the second virtual scene. As such, this avoids the need to resend information that has not changed.

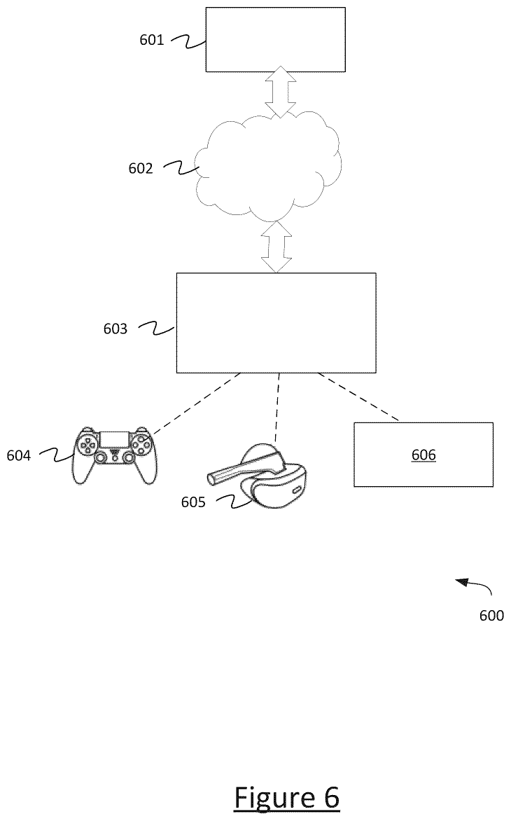

FIG. 6 shows a schematic illustration of a computing system 600 in accordance with the fourth aspect of the invention, the computing system 600 configured to carry out the computer-implemented method of the first aspect of the invention and/or the second aspect of the invention. In FIG. 6, the computing system 600 is shown as comprising a processing device 601, such as a cloud computing device, that is in communication with a client computing device (or computing device) 603 via a communications network 602. The computing system 600 may be a cloud gaming system.

The client device 603 may include, but is not limited to, a video game playing device (games console), a smart TV, a set-top box, a smartphone, laptop, personal computer (PC), USB-streaming device, etc. The client device 603 comprises, or is in communication with, at least one source configured to obtain input data from the user. For example the at least one source may comprise an extended reality display device (PS VR® headset) 605, an input device 604 (DualShock 4®), and a camera 606.

Information passes between the processing device 601 and the client computing device 603 in both directions, as illustrated in FIG. 6.

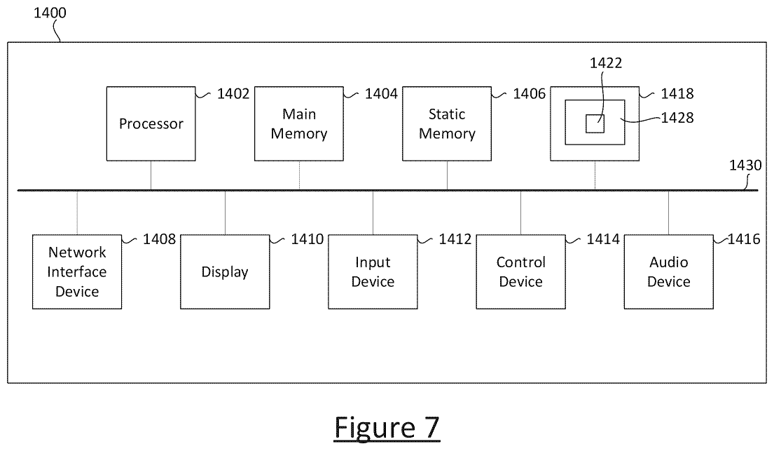

FIG. 7 illustrates a block diagram of one example implementation of a computing device 1400 that can be used for implementing the method shown in FIGS. 1, 2 and 3 and described throughout the detailed description. The computing device 1400 may be (or form part of) the client computing device 603, or the processing device 601.

The computing device 1400 is associated with executable instructions for causing the computing device to perform any one or more of the methodologies discussed herein. In alternative implementations, the computing device 1400 may be connected (e.g., networked) to other machines in a Local Area Network (LAN), an intranet, an extranet, or the Internet. Optionally, a plurality of such computing devices may be used. The computing device may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single computing device is illustrated, the term “computing device” shall also be taken to include any collection of machines (e.g., computers) that individually or jointly execute a set (or multiple sets) of instructions to perform any one or more of the methodologies discussed herein.

The example computing device 1400 includes a processing device 1402, a main memory 1404 (e.g., read-only memory (ROM), flash memory, dynamic random-access memory (DRAM) such as synchronous DRAM (SDRAM) or Rambus DRAM (RDRAM), etc.), a static memory 1404 (e.g., flash memory, static random-access memory (SRAM), etc.), and a secondary memory (e.g., a data storage device 1418), which communicate with each other via a bus 1430.

Processing device 1402 represents one or more general-purpose processors such as a microprocessor, central processing unit, or the like. More particularly, the processing device 1402 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 1402 may also be one or more special-purpose processing devices such as an application specific integrated circuit (ASIC), a field programmable gate array (FPGA), a digital signal processor (DSP), network processor, or the like. Processing device 1402 is configured to execute the processing logic (instructions 1422) for performing the operations and steps discussed herein.

The computing device 1400 may further include a network interface device 1408. The computing device 1400 also may include a video display unit 1410 (e.g., a liquid crystal display (LCD) or a cathode ray tube (CRT)), an alphanumeric input device 1412 (e.g., a keyboard or touchscreen), a cursor control device 1414 (e.g., a mouse or touchscreen), and an audio device 1414 (e.g., a speaker).

The data storage device 1418 may include one or more machine-readable storage media (or more specifically one or more non-transitory computer-readable storage media) 1428 on which is stored one or more sets of instructions 1422 embodying any one or more of the methodologies or functions described herein. The instructions 1422 may also reside, completely or at least partially, within the main memory 1404 and/or within the processing device 1402 during execution thereof by the computer system 1400, the main memory 1404 and the processing device 1402 also constituting computer-readable storage media.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid-state memory, magnetic tape, a removable computer diskette, a random-access memory (RAM), a read-only memory (ROM), a rigid magnetic disc, and an optical disk, such as a CD-ROM, CD-R/W or DVD.

In an implementation, the modules, components and other features described herein can be implemented as discrete components or integrated in the functionality of hardware components such as ASICS, FPGAs, DSPs or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “providing”, “calculating”, “computing,” “identifying”, “detecting”, “establishing”, “training”, “determining”, “storing”, “generating”, “checking”, “obtaining” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is to be understood that the above description is intended to be illustrative, and not restrictive. Many other implementations will be apparent to those of skill in the art upon reading and understanding the above description. Although the disclosure has been described with reference to specific example implementations, it will be recognised that the disclosure is not limited to the implementations described but can be practiced with modification and alteration within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A computer-implemented method comprising:
receiving, at a processing device, data defining a first virtual scene associated with a client computing device, wherein the first virtual scene comprises a plurality of virtual objects;
performing, by the processing device, transparency sorting of the virtual objects, wherein said transparency sorting comprises assigning each virtual object of the plurality of virtual objects to a respective plane of an overlapping stack of planes forming the first virtual scene;
transmitting, from the processing device to the client computing device, information defining an order in which the plurality of objects should be drawn based on the overlapping stack of planes.

2. The computer-implemented method of claim 1, further comprising:
determining, by the processing device, a visibility of each virtual object of the plurality of virtual objects;
wherein, in response to determining that a portion of a virtual object is occluded, the method comprises transmitting, from the processing device to the client computing device, information indicating that the occluded portion of the virtual object should not be rendered.

3. The computer-implemented method of claim 1, wherein performing the transparency sorting comprises:
determining a characteristic of a first virtual object of the plurality of virtual objects and determining a characteristic of a second virtual object of the plurality of virtual objects;
comparing the characteristic of the first virtual object and the characteristic of the second virtual object;
assigning, at least partially based on the comparison, the first virtual object to a first plane and the second virtual object to a second plane, and defining a relative order of the first plane and the second plane in the overlapping stack.

4. The computer-implemented method of claim 3, wherein the characteristic is a depth characteristic, an opacity characteristic or a render priority ranking.

5. The computer-implemented method of claim 3, further comprising:
determining at least one portion of overlap between the first virtual object and the second virtual object, and
determining a characteristic of the portion of overlap.

6. The computer-implemented method of claim 5, wherein the characteristic is a colour or a hue.

7. The computer-implemented method of claim 1, wherein performing the transparency sorting comprises:
dividing the first virtual scene into at least a first sub-portion and a second sub-portion; and
assigning each virtual object of the plurality of virtual objects in the first sub-portion to a respective plane of a first overlapping stack of planes forming the first sub-portion; and
assigning each virtual object of the plurality of virtual objects in the second sub-portion to a respective plane of a second overlapping stack of planes forming the second sub-portion of the virtual scene.

8. The computer-implemented method of claim 7, wherein the first virtual scene is divided into a plurality of sub-portions, wherein each sub-portion is defined by a grid.

9. The computer-implemented method of claim 1, wherein the processing device is a cloud computing device.

10. The computer-implemented method of claim 1, further comprising:
storing, at the processing device or a remote storage resource associated with the processing device, the information defining the order in which the plurality of objects should be drawn and/or the plane assigned to each virtual object in the first virtual scene.

11. The computer-implemented method of claim 1, further comprising:
receiving, at the processing device, data defining a second virtual scene associated with the client computing device, wherein the second virtual scene succeeds the first virtual scene and the second virtual scene comprises a second plurality of virtual objects;
performing, by the processing device, transparency sorting of the virtual objects in the second virtual scene, wherein said transparency sorting comprises assigning each virtual object of the second plurality of virtual objects to a respective plane of an overlapping stack of planes forming the second virtual scene;
transmitting, from the processing device to the client computing device, information defining an order in which the second plurality of objects should be drawn in the second virtual scene based on the overlapping stack of planes.

12. The computer-implemented method of claim 11, wherein transmitting, from the processing device to the client computing device, information defining an order in which the plurality of objects should be drawn in the second virtual scene, comprises:
comparing the information defining the plane assigned to each virtual object in the second virtual scene to the information defining the plane assigned to each virtual object in the first virtual scene; and
transmitting the delta, or differences, between the first virtual scene and the second virtual scene.

13. The computer-implemented method of claim 11, further comprising:
identifying one or more virtual objects that are common between the first virtual scene and the second virtual scene; and
assigning each common virtual object a respective predicted plane in the overlapping stack of planes forming the second virtual scene, at least partially based on the plane assigned to the virtual object in the first virtual scene.

14. The computer-implemented method of claim 13, wherein performing transparency sorting of the virtual objects in the second virtual scene comprises:
updating the respective predicted plane assigned to each common virtual object to a respective finalised plane assigned to each common virtual object.

15. A computer-implemented method comprising:
sending, to a processing device, data defining a first virtual scene associated with a client computing device, the first virtual scene comprising a plurality of virtual objects, wherein each virtual object of the plurality of virtual objects is assigned a respective plane of an overlapping stack of planes forming the first virtual scene;
receiving, at the client computing device, information defining an order in which the plurality of objects should be drawn in the first virtual scene based on the overlapping stack of planes; and
rendering, at the client computing device, the first virtual scene.

16. The computer-implemented method of claim 15, further comprising:
receiving information indicating that a portion of one of the virtual objects of the plurality of virtual objects in the first virtual scene is occluded; and
removing data defining the occluded portion of the virtual object from data defining the first virtual scene for rendering, such that rendering the first virtual scene does not include rendering the occluded portion of the virtual object.

17. The computer-implemented method of claim 15, wherein the first virtual scene is divided into a plurality of sub-portions and receiving, at the client computing device, the information defining an order in which the plurality of objects should be drawn in the first virtual scene, comprises:
receiving information defining an order in which the plurality of virtual objects should be drawn in each sub-portion of the first virtual scene.

18. The computer-implemented method of claim 15, further comprising:
receiving, at the client computing device, information defining an order in which a second plurality of objects should be drawn in a second virtual scene, the second virtual scene succeeding the first virtual scene; and
rendering, at the client computing device, the second virtual scene.

19. The computer-implemented method of claim 18, wherein the information defining an order in which the second plurality of objects should be drawn in the second virtual scene comprises the delta, or differences, between the first virtual scene and the second virtual scene.

20. A non-transitory computer-readable storage medium comprising instructions which, when executed by a processing device in response to said processing device receiving data defining a first virtual scene associated with a client computing device, wherein the first virtual scene comprises a plurality of virtual objects, cause the processing device to:
perform transparency sorting of the virtual objects, wherein said transparency sorting comprises assigning each virtual object of the plurality of virtual objects to a respective plane of an overlapping stack of planes forming the first virtual scene;
transmit, from the processing device to the client computing device, information defining an order in which the plurality of objects should be drawn based on the overlapping stack of planes.
